(19) United States
(12) Patent Application Publication
(10) Pub. No.: US 2019/0302918 A1
(43) Pub. Date: Oct. 3, 2019

(54) CURVED SENSOR DEVICE AND METHOD OF MANUFACTURE

(71) Applicant: Sharp Kabushiki Kaisha, Osaka (JP)

(72) Inventor: Andrew Kay, Oxford (GB)

(21) Appl. No.: 15/938,381

(22) Filed: Mar. 28, 2018

(51) Int. Cl. G06F 3/044

(52) U.S. Cl. CPC G06F 3/044; G06F 2203/04103; G06F 2203/04112

(57) ABSTRACT

An electronic device includes a first planar layer having a plurality of first sensing elements and first signal connections connected between the first sensing elements, a second planar layer having a plurality of second sensing elements and second signal connections connected between the second sensing elements, and a controller in electrical communication with the first sensing elements and the second sensing elements. The first sensing elements and the first signal connections are arranged substantially in a first direction. The second sensing elements and the second signal connections are arranged substantially in a second direction perpendicular to the first direction. One of the first planar layer and the second planar layer overlays the other of the first planar layer and the second planar layer forming a mesh. Each of the first planar layer and the second planar layer are two-dimensional and flexed together to form a three-dimensional curved shape.

### TECHNICAL FIELD

The present invention has application within the field of sensor panels, and in particular, touch sensor panels used for applications such as phones, tablets, portable PCs and other consumer electronics.

### BACKGROUND ART

Sensor panels are generally used to sense touch, proximity, fingerprints, and images. The panels are configured to detect changes in capacitance, resistance or inductance, the amount of incident or reflected radiation, or other physical phenomena.

Touch sensor panels are suitable for use in many kinds of electronic products. For example, consumer electronics, such as phones, tablets, portable PCs and cameras, are controlled by touch panels. Touch panels are also suitable for use in car information and entertainment systems, customer information points, ATMs, product or ticket dispensers, and public booking systems. Touch panels are used for various functions such as controlling robots and adjusting lighting. A touch sensor may also be used in conjunction with a display panel, so that the sensing function appears to coincide with elements on the display.

In addition to being sensitive to literal touch, such as with the finger of a user, exemplary touch sensors may also be sensitive to other kinds of probes including a specialised stylus, a roughly pen-shaped object, or a gloved finger. One known touch sensor panel includes a capacitive sensor that is driven to be responsive to probing by both conductive and non-conductive objects, as taught in Applicant's commonly owned U.S. Pat. No. 9,105,255 (Brown et al., issued Aug. 11, 2015).

Conventional sensor panels are flat. However, using a flat sensor panel may be disadvantageous in that the flat shape may be inadequate for a sensing area. Moreover, a flat sensor panel may prevent different parts of the sensor from being angled to sense different parts of the environment, such as in a camera or radiation sensor.

One prior attempt to provide a sensor sheet that is curved instead of flat includes forming the electronics for the sensor on a flat substrate that includes a glass or plastic material enabling the sensor sheet to be flexible. After fabrication, the sensor sheet may be curved to a desired shape. However, stretchable sensor sheets are difficult and expensive to manufacture due to the thin layers of circuitry being damaged during the stretching process.

In other prior attempts to provide a sensor sheet having a non-flat shape, a flat, flexible sensor sheet may be shaped into a cylinder or a cone. Forming the sheet as a cylinder or cone does not require stretching the sheet since cylinders and cones are shapes without intrinsic curvature. However, forming spherical or ellipsoidal structures may not be easily achievable with non-stretchable material since the surfaces of a sphere or an ellipsoid have intrinsic curvature.

Prior attempts to provide touch sensors have also included attempts to improve the accuracy of sensing of a flat touch sensor. Touch sensors generally respond to touches at each point on the surface of the sensor, and each point provides a different signal to distinguish the points. Touch sensors distinguish not only the position of a touch, but also detect accurately when a touch starts and ends. Accordingly, a touch sensor is patterned into sensing elements. If the touch sensor is in the form of a capacitive touch panel, the sensing element is a patch of thin conductive material connected to controller electronics outside of the sensor area. The elements may be fairly numerous to achieve good spatial resolution and touch detection, and the number of sensing elements increases roughly proportionally with the total area of the sensor, i.e. approximately the number of sensor element rows multiplied by the number of columns.

Each sensor element needs a unique connection to the driver electronics, such that the number of connections increases proportionately with the total area of the sensor. The sensor elements may be interconnected to form a substantially two-dimensional mesh to reduce the number of connections. The horizontal and vertical parts of the mesh are generally made in two different layers and separated by an insulator when the sensor is a capacitive sensor, such that sensor elements are addressed by row and column. The arrangement allows the number of wires and connections to increase roughly proportionally with only the square root of the area, i.e. approximately the number of sensor element rows plus the number of columns. Thus, using the mesh arrangement improves accuracy and is more cost-effective.

However, using the mesh arrangement may limit the shape and flexibility of the sensor since the row and column signals must be able to cross each other without interacting so that each of the sensor elements is addressed by row and column. Thus, the circuit cannot be formed entirely in one layer. When multiple sheets are used to create the layers, the substrate of one sheet acts as an insulator between the two signal layers.

One prior attempt to form a touch sensor in the shape of a hemisphere is disclosed in U.S. Pat. No. 9,563,298 (Sakashita et al., issued Feb. 7, 2017). The method of manufacturing the touch sensor involves stretching the substrate to cover the surface, and providing a means that forces the inevitable breaking of the substrate to occur in strategic places. The method uses a single layer and requires a number of signal wires that is proportional to the number of touch regions.

Another prior attempt to form a touch sensor is disclosed in U.S. Patent Publication No. 2007/0229469 (Seguine, published Oct. 4, 2007). The method of manufacturing includes forming the touch panel having a curved surface by planar approximation using hexagonal and pentagonal tiles. Several tiles are connected to each signal wire as a group, so each group is essentially a single touch region with a unique signal wire. The prior attempt is disadvantageous since a fine determination of touch position and exact determination of the instant of a touch would not be possible using only a single layer and a small number of signal wires.

### SUMMARY OF INVENTION

There is a need in the art, therefore, for an accurate sensor panel with substantial intrinsic curvature that may wrap around part of a sphere or ellipsoid. In addition, it would be advantageous to provide a sensor device with substantial intrinsic curvature, and further having signal wires that form an approximately two-dimensional mesh of multiple layers so that the number of signals grows approximately proportionally to the square root of the number of sensing regions.

The present invention provides for a convex, hemispherical, and capacitive sensor. The sensor may be a touch sensor or in alternative embodiments, an emitter. Configurations of the sensor described in this disclosure solve problems of existing touch sensors by providing two-dimensional layers of sensing elements and signal connections that may be overlaid to form a mesh arrangement, and flexed or wrapped into a three-dimensional partial ellipsoidal body having at least a top pole to provide at least a hemispherical shape, and a flattened surface opposite the top pole at the bottom of the partial ellipsoidal body. The signal connections enter or exit at an equator line that is located at the bottom of the ellipsoidal body. The signal connections connect a touch controller with the sensor elements. One of the layers includes sensor elements and signal connections that extend substantially vertically from the equator line towards the pole of the ellipsoidal body along lines of longitude. The other includes sensor elements and signal connections that extend around lines of latitude of the ellipsoidal body. The sensing elements or regions are spaced along the mesh arrangement so that the sensing elements interact with each other to create capacitances which are measured by the touch controller to produce an output.

The sensor device of the present disclosure is advantageous in achieving improved spatial resolution and touch detection using a mesh arrangement to reduce the number of wires and connections between sensor elements and the controller. The sensor device addresses each of the sensing elements by providing two overlaying layers that form the mesh arrangement, such that each sensing element does not require a unique and dedicated wire. The layers each include a planar pattern having parts, such as petal members and coils, that are narrow to reduce the amount of stretching or contracting of the layer when the layers are flexed or wrapped to form the three-dimensional ellipsoidal body. Using a reduced number of wires and connections is also cost-effective.

According to one aspect of the invention, an electronic device includes a first planar layer having a plurality of first sensing elements and a plurality of first signal connections connected between the first sensing elements, and the plurality of first sensing elements and the plurality of first signal connections are arranged substantially in a first direction (e.g., vertically). The device includes a second planar layer having a plurality of second sensing elements and a plurality of second signal connections connected between the second sensing elements, and the plurality of second sensing elements and the plurality of second signal connections are arranged substantially in a second direction perpendicular to the first direction (e.g., horizontally). The device further includes a controller in electrical communication with the first sensing elements and the second sensing elements. One of the first planar layer and the second planar layer overlays the other of the first planar layer and the second planar layer forming a mesh, and each of the first planar layer and the second layer are two-dimensional and flexed together to form a three-dimensional curved shape.

According to another aspect of the invention, a sensing device includes a partial ellipsoidal body having a pole and a distal surface distally opposite the pole. The partial ellipsoidal body includes a first layer having a plurality of first sensing elements and a plurality of first signal connections connected between the first sensing elements, and the plurality of first sensing elements and the plurality of first signal connections are arranged in a first direction along lines of longitude that extend between the pole and the distal surface. The partial ellipsoidal body further includes a second layer having a plurality of second sensing elements and a plurality of second signal connections connected between the second sensing elements, and the plurality of second sensing elements and the plurality of second signal connections are arranged in a second direction perpendicular to the first direction along lines of latitude that extend along planes parallel to the distal surface. One of the first layer and the second layer overlays the other of the first layer and the second layer forming a mesh. The sensing device further includes a controller in electrical communication with the first sensing elements and the second sensing elements.

According to still another aspect of the invention, a method for manufacturing a three-dimensional sensing device includes forming a first planar layer having a plurality of first sensing elements and a plurality of first signal connections connected between the first sensing elements, and the plurality of first sensing elements and the plurality of first signal connections are arranged substantially in a first direction (e.g., vertically). The method further includes forming a second planar layer having a plurality of second sensing elements and a plurality of second signal connections connected between the second sensing elements, and the plurality of second sensing elements and the plurality of second signal connections are arranged substantially in a second direction perpendicular to the first direction (e.g., horizontally). The method further includes connecting the first planar layer and the second layer to a controller, and the controller is in electrical communication with the first sensing elements and the second sensing elements. The method further includes overlaying one of the first planar layer and the second planar layer over the other of the first planar layer and the second planar layer to form a mesh, and flexing the first planar layer and the second planar layer to form a three-dimensional curved shape.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 is a drawing depicting an isometric view of a three-dimensional sensing device in accordance with embodiments of the present invention.

FIG. 2 is a drawing depicting a first layer of the sensing device shown in FIG. 1 in two-dimensional form.

FIG. 3 is a drawing depicting a single petal member of the first layer shown in FIG. 2.

FIG. 4 is a drawing depicting a first layer of the sensing device shown in FIG. 1 according to a second exemplary embodiment.

FIG. 5 is a drawing depicting the first layer shown in FIG. 4 with the sensor elements and the signal connections arranged in each petal member of the layer.

FIG. 6 is a drawing depicting an isometric view of the first layer shown in FIG. 2 flexed to form a three-dimensional body.

FIG. 7 is a drawing depicting a second layer of the sensing device shown in FIG. 1 in two-dimensional form.

FIG. 8 is a drawing depicting a second layer of the sensing device shown in FIG. 1 according to a second embodiment.

FIG. 9 is a drawing depicting the second layer shown in FIG. 7 with the sensor elements and the signal connections arranged in each coil of the layer.

FIG. 10 is a drawing depicting an isometric view of the second layer of the sensing device shown in FIG. 7 flexed to form a three-dimensional body.

FIG. 11 is a drawing depicting a petal member of the first layer shown in FIG. 4 overlaid with the coils of the second layer shown in FIG. 7.

FIG. 12 is a drawing depicting a sensing system for the sensing device shown in FIG. 1.

### DESCRIPTION OF EMBODIMENTS

Embodiments of the present invention will now be described with reference to the drawings, wherein like reference numerals are used to refer to like elements throughout. It will be understood that the figures are not necessarily to scale.

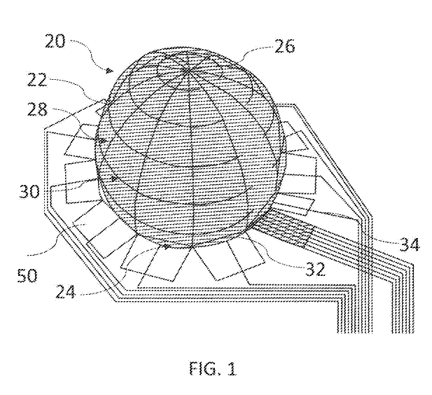

FIG. 1 is a drawing depicting an isometric view of an exemplary sensing device 20 in accordance with embodiments of the present invention. In exemplary embodiments, the sensing device 20 has convex surfaces and is ellipsoidal or hemispherical in shape. The sensing device 20 includes a partial ellipsoidal body 22 having a pole 26 and a distal surface 24 opposite from the pole 26. The partial ellipsoidal body 22 may be hemispherical in shape or may be a comparable hemi-ellipsoid shape. The distal surface 24 is flattened enabling the ellipsoidal body 22 to engage against on a flat substrate in a particular application, such that the ellipsoidal body 22 is formed as part of a full ellipsoid shape. In exemplary embodiments in which the partial ellipsoidal body is formed as a partial spherical body, the spherical body is formed as part of a full spherical shape that has a flattened bottom surface. The ellipsoidal body 22 includes lines of longitude 28 that extend vertically between the distal surface 24 and the pole 26, and lines of latitude 30 that extend along planes parallel to the distal surface 24.

The sensing device 20 includes a plurality of sensing elements, or electrodes, and signal connections that are arranged along the lines of longitude 28 and the lines of latitude 30. The signal connections enter and exit at an equator line 32 that is located at the bottom of the ellipsoidal body 22 at the surface 24, and extends along a plane that is parallel to the lines of latitude 30. The ellipsoidal body 22 is in communication with a control system via wires or signal connection lines 34 that extend outwardly from the equator line 32. The sensing elements and signal connections that extend along the lines of longitude 28 and the lines of latitude 30 form a mesh arrangement such that the sensing elements may interact with each other to generate an output that is measurable by the control system. In exemplary embodiments, the output may correspond to a change in capacitance, resistance or inductance, incident or reflected radiation, or other measurable physical phenomena.

The sensing device 20 is formed of two non-integrally formed two-dimensional planar layers or sheets that are overlaid and flexed or wrapped to form the three-dimensional ellipsoidal body 22 shown in FIG. 1. Each layer has a planar pattern and may be pre-formed in a sheet that includes various electronics and transducers forming a circuit of the sensing device 20. Each layer may then be cut from the sheet before being flexed or wrapped to form the ellipsoidal body 22.

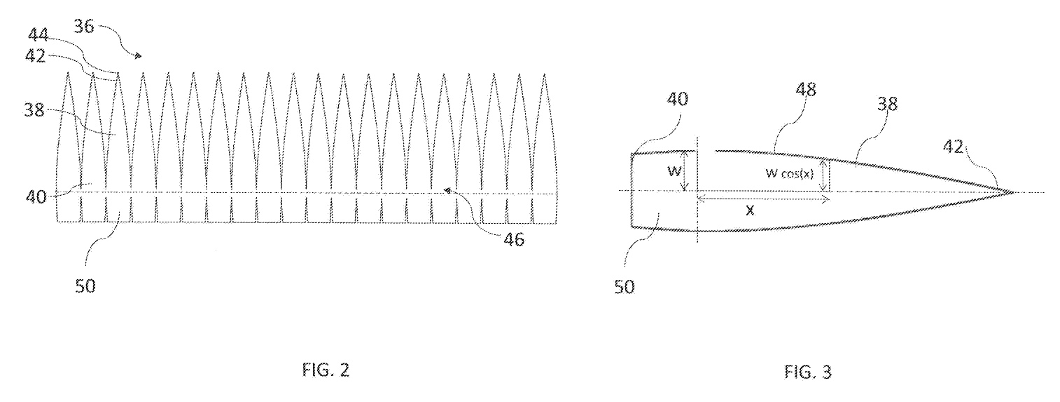

Referring in addition to FIGS. 2-6, one of the two layers of the sensing device 20 includes a plurality of sensing elements and signal connections that extend in substantially in a first direction (e.g., a vertical direction). In the context of this disclosure, the term “substantially” in connection with directional indications is intended to allot for the curvature of the device. In other words, the first direction runs between the pole and the distal surface along the curvature of the device.

FIG. 2 is a drawing depicting a first layer 36 of the sensing device 20 in two-dimensional and planar form. The first layer 36 includes a row of vertically extending petal members 38, i.e., the petal members extend in the first direction. Each petal member 38 includes at least one column of sensing elements that extends in said first direction and signal connections that are arranged in an orientation in the first (vertical) direction. Each of the petal members 38 is tapered or narrowed from a first end 40 to a second end 42. As shown in FIG. 2, the petal members 38 may taper to a single tip or point 44. When in the three-dimensional form as shown in FIG. 1, the first end 40 of the petal members 38 is proximate the distal surface 24 and the second end 42 of the petal members 38 is proximate the pole 26 such that each of the petal members 38 narrow from the surface 24 to the pole 26.

The first layer 36 may include any suitable number N of petal members 38 that each have a width W, as shown in FIG. 3. The total width of the first layer 36 when in planar form is determined by the distance across the base 46 of the petal members 38. The total width is at least equal to the circumference of the equator line 32 of the ellipsoidal body 22 (as shown in FIG. 1). In an exemplary embodiment in which the ellipsoidal body 22 is a hemispherical or spherical body, the circumference is calculated using the equation 2πr, where r is the radius of the hemispherical body. The height of each petal member 38, or the distance from the first end 40 to the point 44, is equal to a quarter of a circle from the equator line 32 to the pole 26. The height is calculated using the equation πr². In an exemplary embodiment using a body having an ellipsoidal shape, the petals may each have different heights.

The dimensions of the first layer 36 may be selected to prevent vertical stretching of the first layer 36 when flexing or wrapping the first layer 36 to form the three-dimensional ellipsoidal body 22. The shape of a side 48 of each petal member 38 is approximately a cosine curve having an amplitude of half the width W. The width may be slightly altered to ensure sufficient flexing and wrapping of the first layer 36, depending on the flexibility and stretchability of the material of the first layer 36.

Each petal member 38 has a protruding tab 50 that protrudes from the first end 40 of the petal member 38. As shown in FIGS. 2 and 3, the protruding tab 50 may be arranged planar with the petal members 38 when the first layer 36 is in the two-dimensional form. When the first layer 36 is flexed or wrapped into the three-dimensional form as shown in FIG. 1, the protruding tab 50 is bent radially outwardly from the base 46 and the equator line 32. As shown in FIG. 1, the protruding tab 50 carries the signal wires or connection lines 34 in the petal members 38 from the sensing device 20 to the control system. The first layer 36 may have any suitable number of petal members 38. As shown in FIG. 2, an exemplary first layer 36 may have twelve petal members 38.

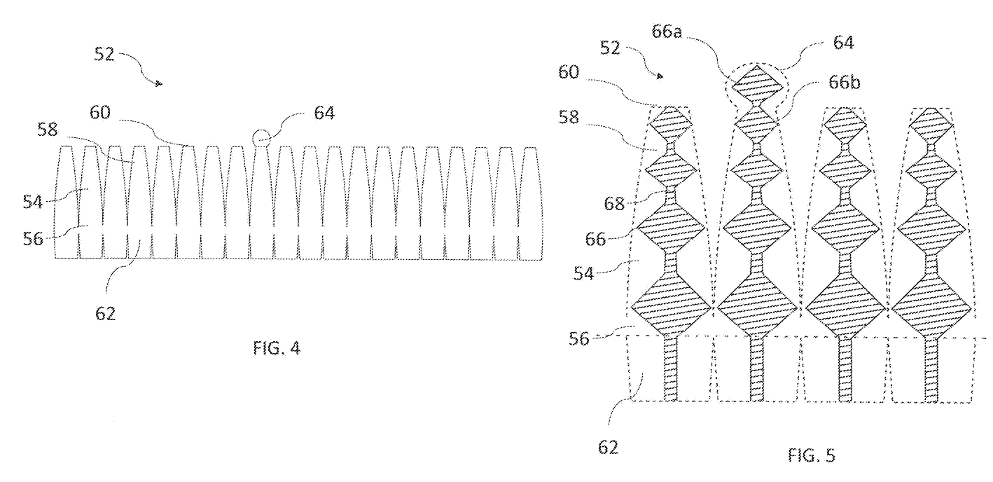

Referring now to FIGS. 4 and 5, a second embodiment of the first planar layer 52 is shown. The first planar layer 52 includes a plurality of petal members 54 that are truncated from a first end 56 to a second end 58, such that the second end 58 has a flat end 60 instead of the pointed end shown in FIGS. 2 and 3. The first planar layer 52 also includes protruding tabs 62 that extend from the first end 56. One of the truncated petal members 54 has a circular cap 64 arranged on the second end 58. When the first planar layer 52 is flexed or wrapped to form the three-dimensional ellipsoidal body 22 (as shown in FIG. 1), the cap 64 covers the pole 26 of the ellipsoidal body 22.

Referring now to FIG. 5, the petal structure is overlaid on the sensor circuitry required for the sensors of the system. The petal structure is used to guide the configuration of the active circuitry. Any unused portions of the petal structure, or the portions that do not include sensor circuitry, may be removed from the structure. Accordingly, the petal members 54 may have any suitable shape so long as the circuit parts of the first planar layer 52 are arranged in an optimal spatial arrangement for sensing and do not overlap after wrapping. Each petal member 54 includes a column of sensor elements 66 and signal connections 68 connected between the sensor elements 66. The sensor elements 66 may decrease in size from the first end 56 of the petal member 54 to the second end 58 of the petal member 54. As shown in FIG. 5, the cap 64 may include a sensor element 66a that is larger in size as compared with the vertical most sensor element 66b arranged in the petal member 54.

In exemplary embodiments, if the sensor elements 66 have a smaller size, the petal member 54 may include more than one vertical column of sensor elements 66 and signal connections 68. Smaller sensor elements may be advantageous in providing more precision. The sensor elements 66 may be diamond-shaped electrodes or the sensor elements 66 may have any other suitable shape. The sensor elements 66 may be capacitive sensor elements or mutual capacitive sensor elements. Each sensor element 66 may have a different shape. The diamond sensor pattern may be distorted to fit on the planar sheet to accommodate manipulating the pattern during flexing or wrapping of the first layer 52 to form the three-dimensional ellipsoidal body 22 (as shown in FIG. 1). Before the first layer 52 is flexed or wrapped, some of the material surrounding the diamond sensor pattern are cut or removed depending on the robustness and the flexibility of the material. Any suitable material may be used.

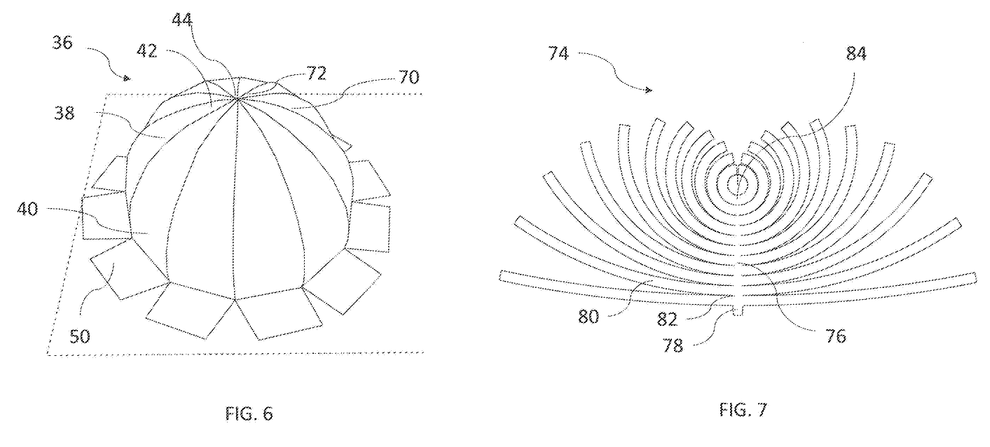

Referring now to FIG. 6, the planar arrangement of the first layer 36, according to the first embodiment of the first layer, is flexed or wrapped to form the three-dimensional ellipsoidal body 70. The petal members 38 extend in the first direction (vertically) from the first ends 40 to meet at a top end of the ellipsoidal body 70. The points 44 of the petal members 38 contact each other at the top. The second ends 42 of the petal members 38 are curved in toward each other at the north pole 72 such that the ellipsoidal body 70 has convex surfaces and a hemispherical shape. The protruding tabs 50 extend outwardly from a bottom of the ellipsoidal body 70 proximate the first ends 40 of the petal members 38. The protruding tabs 50 are generally arranged in a planar arrangement and circumferentially around the bottom of the ellipsoidal body 70.

Referring now to FIGS. 7-10, a second layer 74 of the sensing device 20 (as shown in FIG. 1) is shown. The second layer 74 includes a plurality of sensing elements and signal connections that extend substantially in a second direction perpendicular to the first direction (e.g., horizontal direction), such that the horizontal second layer 74 and the vertical first layer 36, 52 are overlaid to provide overlapping signal connections. FIG. 7 shows the second layer 74 in a two-dimensional and planar form. The second layer 74 includes a vertical spine 76 that, when incorporated as part of the device 20 of FIG. 1, extends in the first direction from the equator line 32 (as shown in FIG. 1) to the pole 26 (as shown in FIG. 1) when the second layer 74 is flexed or wrapped to form the three-dimensional body. The second layer 74 includes a tab 78 that is aligned with the spine 76 when the second layer 74 is in two-dimensional form. When in three-dimensional form, the tab 78 protrudes outwardly from the equator line 32 to carry the signal connections from the three-dimensional body.

The second layer 74 further includes annular sections or coils 80 that extend outwardly from sides of the spine 76 in the second direction. When in two-dimensional form, the radius of the coils 80 may decrease as the spine 76 extends from a bottom end 82 to a top end 84. FIG. 8 shows the second layer 74 according to a second exemplary embodiment in which the coils 80 may only extend from one side of the spine. When in the three-dimensional form, the coils 80 of the second layer 74 extend along the lines of latitude 30 (as shown in FIG. 1) and include rows of sensing elements and signal connections.

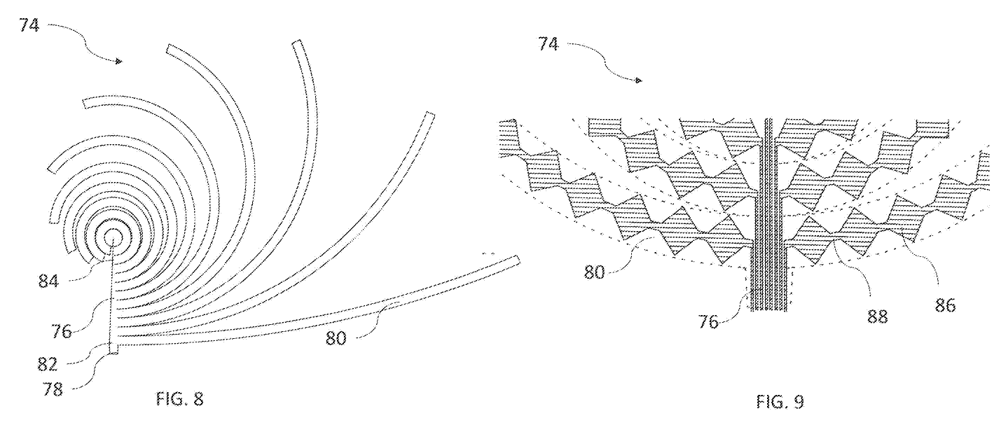

FIG. 9 shows the second layer 74 overlaid on the sensor circuitry required for the sensors of the system. The coils 80 are used to guide the configuration of the active circuitry. Any unused portions of the coils 80, or the portions that do not include sensor circuitry, may be removed from the structure. Accordingly, the coils 80 may have any suitable shape so long as the circuit parts of the second layer 74 are arranged in an optimal spatial arrangement for sensing and do not overlap after wrapping. A plurality of sensing elements 86 and a plurality of signal connections 88 connected between the sensing elements 86 of the second layer 74 are shown in FIG. 9. The sensing elements 86 may be diamond-shaped electrodes or the sensing elements 86 may have any other suitable shape. The sensing elements 86 may be capacitive sensing elements or mutual capacitive sensing elements. Each sensing element 86 may have a different shape. In exemplary embodiments, the sensing elements 86 may have a smaller shape and more than one row of sensing elements 86 and signal connections may be provided in a single coil 80. The signal connections 88 are all connected to the spine 76 which carries the signal connections 88 to a control system.

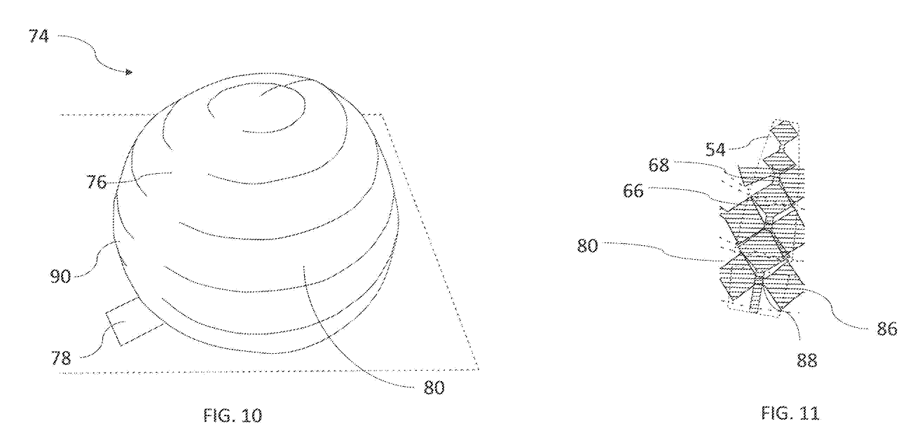

As shown in FIG. 10, the second layer 74 is flexed or wrapped to form a three-dimensional frustum body 90 that is overlaid with the three-dimensional ellipsoidal body 70 of the first layer 36 (as shown in FIG. 6) to form a net or mesh arrangement of electrodes as shown in FIG. 1. If the second layer 74 is overlaid or wrapped around the first layer 36, 52 (as shown in FIG. 6), the coils 80 may conform to the first layer 36 by a small amount of stretching or contracting. Alternatively, the coils 80 may not conform and any potential gaps in the mesh arrangement may be securely glued. After wrapping, signals may travel up the spine 76 and branch out to the horizontal coils 80 to reach the sensing elements.

Referring now to FIG. 11, a drawing depicting one of the petal members 54 according to the second embodiment being overlaid with the coils 80 is shown. The petal member 54 of the first layer or vertical layer 52 (as shown in FIG. 4) is overlaid with the coils 80 of the second layer horizontal layer 74 (as shown in FIG. 7), such that the sensing elements 66 of the first layer 52, or the first sensing elements, cover the gaps between the sensing elements 86 of the second layer 74, or the second sensing elements. The signal connections 68 of the first layer 52 and the signal connections 88 overlap. The coils 80 become narrower toward the pole 26 of the ellipsoidal body 22 (as shown in FIG. 1) at the same rate as the petal members 54 become thinner, or at the same rate as the vertically connected sensing elements 66 become smaller. As the coils 80 become narrower, the sensing elements 86 within the coils 80 become smaller at the same rate. Accordingly, all of the gaps in the mesh arrangement are addressed by the sensing elements.

The signal connections 68, 88 between the sensing elements 66, 86 are provided via a signal wire. As shown in FIG. 11, one signal wire may be provided for each petal member 54 and each coil 80. However, in exemplary embodiments, each petal member 54 and each coil 80 may have two signal wires or signal connections for sensing and discriminating between both conductive and non-conductive stimuli, as disclosed in U.S. Pat. No. 9,105,255. When two signal connections are used, the sensing electrode pattern may also be distorted, rather than precisely diamond-shaped.

The second (horizontal) layer 74 or the first (vertical) layer 52 may be overlaid by the other, and the petal members 54 may be wrapped around the coil 80 or vice versa, so long as a precise geometric arrangement between the layers is achieved. In a configuration in which either the second layer 74 or the first layer 52 is the outermost layer, the outermost layer may be formed to be slightly larger than the innermost layer such that the outermost layer fits snugly over the top of the innermost layer without tension. The amount of enlargement of the outermost layer may be dependent on the thickness of both layers and the method of adhesion between the layers. The layers may have any suitable thickness and any suitable method of adhesion may be used. In exemplary embodiments, the innermost layer may also be glued to a hemispherical former that is formed of any suitable material. Examples of suitable material include glass and plastic.

The planar patterns of the second layer 74 and the first layer 52 are advantageously narrow such that only a small amount of stretching or contraction may occur, and a precise fit between the layers is achieved without damaging the electronics of the layers. Additionally, either of the layers may deviate in conformance from the spherical surface and any hollow interior space may be filled with an adhesive material for rigidity of the sensing device 20 (as shown in FIG. 1). Forming the sensing device 20 may further include providing a cover layer over the top of the sensing layers, i.e. the horizontal layer 74 and the vertical layer 52. The cover layer may be formed by stretching a sheet of plastic over the sensing device 20 and fixing the sheet in place.

Alternatively, the layers could be formed on a pre-formed hemispherical shell or substrate. The layers could be formed over different portions of a spherical body, an ellipsoid body, or other similar intrinsically curved surfaces in three dimensions. Still another alternative method of forming the sensing device 20 may include a manufacturing process that would enable the outermost shell or layer to be formed first and the inner shells being subsequently formed within the outermost shell. In other exemplary embodiments, a combination of forming inner layers and outer layers may be used. For example, an inner layer may be formed and an outer layer may be formed over the inner layer, and subsequently, another inner layer may be formed inside of the initial inner layer.

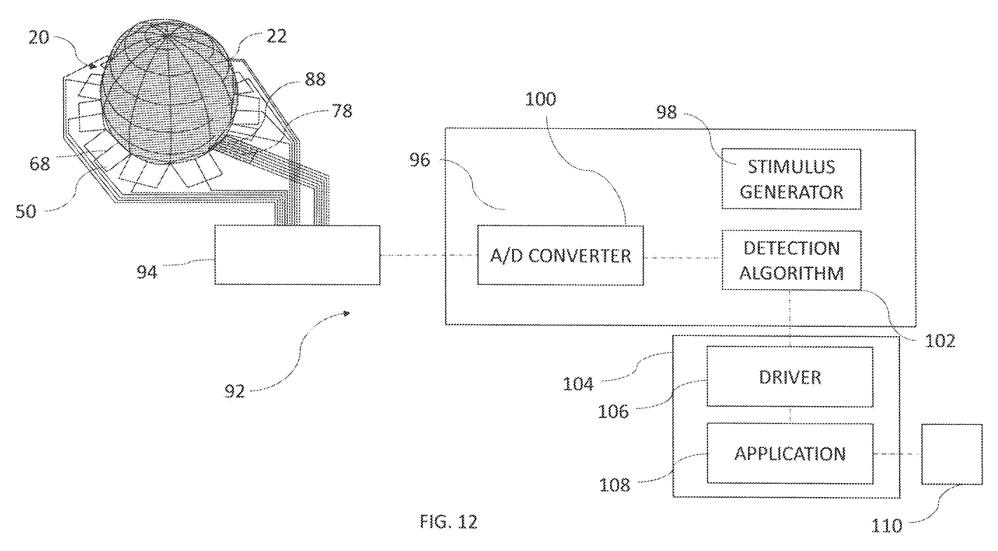

Referring now to FIG. 12, a sensing system 92 is schematically shown. The sensing system 92 includes the sensing device 20 (as shown in FIG. 1) having the plurality of signal connections. As shown in FIG. 12, the protruding tabs 50 of the first layer or the vertical layer 36 extend outwardly from the ellipsoidal body 22 and carry the signal connections 68 to an analog front end 94 of the touch sensing system 92. The protruding tab 78 of the second layer or the horizontal layer 74 also extends outwardly from the ellipsoidal body 22 and is planar with the protruding tabs 50, 62 of the vertical layer 36, 52. The tabs 50, 78 are circumferentially arranged around the bottom of the ellipsoidal body 22. The protruding tab 78 of the horizontal layer 74 also carries the signal connections 88 to the analog front end 94.

The sensing system 92 further includes a device controller 96 that drives and samples the vertical signal connections 68 and the horizontal signal connections 88. The device controller 96 includes a stimulus generator 98 that provides a waveform designed to enable sensing and an analog-to-digital converter 100 that digitizes the outputs of the signal connections 68, 88 after conditioning by the analog front end 94. The output may correspond to a change in capacitance, resistance or inductance, incident or reflected radiation, or other measurable physical phenomena. The device controller 96 further includes a stored detection algorithm 102. The detection algorithm 102 is used to process the digitized signals and output a result that is readable by an application host 104. The application host 104 includes a device driver 106 and runs an application 108 using the sensed information to generate an output 110. In an exemplary application, if the sensing device 20 is used as a touch panel to control an information display, the output 110 may be a signal that drives the display.

The sensing system of the present disclosure provides an accurate sensor panel with substantial intrinsic curvature, such as spherical or ellipsoidal, without having the stretch the substrate layers as done in conventional configurations. In addition, with such substantial intrinsic curvature, the sensing device further has signal wires that form an approximately two-dimensional mesh of multiple layers so that the number of signals grows approximately proportionally to the square root of the number of sensing regions.

The sensing device and system is operable by approximating the intrinsically curved surface by small sections of non-curved material. A conventional hemispherical body has intrinsic curvature such that no part of the body is flat and no part of the body can be precisely modelled by bending a flat surface without stretching or squashing the flat surface. In contrast, the sensing device according to the present application uses smaller pieces that are nearly flat. Thus, by using a sufficient number of petals or coils, the flat planar layers are bendable without stretching to model the curved surface. If needed, any voids may be filled with a conformal glue or gel to help improve the rigidity of the body. Furthermore, if a small amount of stretching is allowed by the materials used, the smaller pieces enable stretching without tearing or damaging the sensing circuitry. When the number of petals or coils is increased, the approximation of the curved surface improves. However, increasing the number of petals or coils also requires increasing the number of wires and sensors and reducing the size of the individual sensors, so an application will have an optimal number of petals or coils.

The sensing device and system disclosed herein may be suitable for use in various applications. Examples of suitable applications include touch sensor panels, or other types of sensor panels that are used in consumer products, such as phones, tablets, portable PCs and cameras. Other suitable applications include car information and entertainment systems, customer information points, ATMs, product or ticket dispensers, and public booking systems. Still another application may include graphics tablets that use sensor panels in conjunction with a special “pen” device.

An aspect of the invention is an electronic device including a first planar layer having a plurality of first sensing elements and a plurality of first signal connections connected between the first sensing elements, a second planar layer having a plurality of second sensing elements and a plurality of second signal connections connected between the plurality of second sensing elements, and a controller in electrical communication with the plurality of first sensing elements and the plurality of second sensing elements. The plurality of first sensing elements and the plurality of first signal connections are arranged substantially in a first direction. The plurality of second sensing elements and the plurality of second signal connections are arranged substantially in a second direction perpendicular to the first direction. One of the first planar layer and the second planar layer overlays the other of the first planar layer and the second planar layer forming a mesh. Each of the first planar layer and the second planar layer are two-dimensional and flexed together to form a three-dimensional curved shape.

In an exemplary embodiment of the electronic device, the plurality of first sensing elements and the plurality of second sensing elements are capacitive sensing elements that form a capacitive touch panel.

In an exemplary embodiment of the electronic device, the first planar layer and the second planar layer form a partial ellipsoidal body having a pole and a flattened distal surface opposite the pole.

In an exemplary embodiment of the electronic device, the partial ellipsoidal body is formed as a partial spherical body.

In an exemplary embodiment of the electronic device, the first planar layer includes a row of petal members extending in the first direction, and each of the petal members includes at least one column of the plurality of first sensing elements and the plurality of first signal connections.

In an exemplary embodiment of the electronic device, the petal members are tapered from a first end to a second end, and the plurality of first sensing elements decrease in size from the first end to the second end of the petal members.

In an exemplary embodiment of the electronic device, each of the petal members has a tab portion protruding from the first end, and the tab portion is in electrical communication with the controller.

In an exemplary embodiment of the electronic device, the second planar layer includes a spine that extends in the first direction and a plurality of annular coils that extend from the spine in the second direction. Each of the plurality of annular coils includes at least one row of the plurality of second sensing elements and the plurality of second signal connections.

In an exemplary embodiment of the electronic device, the electronic device includes a preformed substrate of glass or plastic, and the first planar layer is glued to the substrate and the second layer is glued to the second planar layer.

In an exemplary embodiment of the electronic device, the plurality of first sensing elements and the plurality of second sensing elements are diamond-shaped.

In an exemplary embodiment of the electronic device, the first planar layer overlays the second planar layer and the first planar layer has an outer diameter that is larger than the second planar layer, or the second planar layer overlays the first planar layer and the second planar layer has an outer diameter that is larger than the first planar layer.

Another aspect of the invention is a sensing device including a partial ellipsoidal body having a pole and a distal surface distally opposite the pole. The partial ellipsoidal body includes a first layer having a plurality of first sensing elements and a plurality of first signal connections connected between the first sensing elements, and a second layer having a plurality of second sensing elements and a plurality of second signal connections connected between the second sensing elements. The plurality of first sensing elements and the plurality of first signal connections are arranged in a first direction along lines of longitude that extend between the pole and the distal surface. The plurality of second sensing elements and the plurality of second signal connections are arranged in a second direction perpendicular to the first direction along lines of latitude that extend along planes parallel to the distal surface. One of the first layer and the second layer overlays the other of the first layer and the second layer forming a mesh. The sensing device further includes a controller in electrical communication with the first sensing elements and the second sensing elements.

In an exemplary embodiment of the sensing device, the partial ellipsoidal body is formed as a partial spherical body.

In an exemplary embodiment of the sensing device, the first sensing elements and the second sensing elements are capacitive sensing elements that form a capacitive touch panel.

In an exemplary embodiment of the sensing device, the first layer includes a plurality of petal members that extend along the lines of longitude and each include at least one column of the plurality of first sensing elements and the plurality of first signal connections. The petal members are tapered from the distal surface to the pole and the plurality of first sensing elements decrease in size from the distal surface to the second pole. Each of the petal members has a tab portion that protrudes from the distal surface and is in electrical communication with the controller.

In an exemplary embodiment of the sensing device, the second layer includes a spine that extends from the pole to the distal surface and a plurality of annular coils that extend from the spine. Each of the plurality of annular coils includes at least one row of the plurality of second sensing elements and the plurality of second signal connections.

In an exemplary embodiment of the sensing device, the sensing device includes a preformed substrate of glass or plastic. The first layer is glued to the former and the second layer is glued to the second planar layer.

In an exemplary embodiment of the sensing device, the plurality of first sensing elements and the plurality of second sensing elements are diamond-shaped.

Still another aspect of the invention is a method for manufacturing a three-dimensional sensing device. The method includes forming a first planar layer having a plurality of first sensing elements and a plurality of first signal connections connected between the first sensing elements and forming a second planar layer having a plurality of second sensing elements and a plurality of second signal connections connected between the second sensing elements.

The plurality of first sensing elements and the plurality of first signal connections are arranged substantially in a first direction. The plurality of second sensing elements and the plurality of second signal connections are arranged substantially in a second direction perpendicularly to the first direction. The method further includes connecting the first planar layer and the second layer to a controller and the controller is in electrical communication with the plurality of first sensing elements and the plurality of second sensing elements. The method further includes overlaying one of the first planar layer and the second planar layer over the other of the first planar layer and the second planar layer to form a mesh, and flexing the first planar layer and the second planar layer to form a three-dimensional curved shape.

In an exemplary embodiment of the sensing device, the method further includes forming the first planar layer having a plurality of petal members that extend along the lines of longitude, overlaying the plurality of petal members over the plurality of first sensing elements and the plurality of first signal connections, forming the second planar layer having a spine that extends from the pole to the distal surface and a plurality of annular coils that extend from the spine, overlaying the plurality of annular coils over the plurality of second sensing elements and the plurality of second signal connections, removing portions of the plurality of petal members that do not contain the plurality of first sensing elements and the plurality of first signal connections, and removing portions of the plurality of annular coils that do not contain the plurality of second sensing elements and the plurality of second signal connections.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

### INDUSTRIAL APPLICABILITY

The present invention relates to touch sensor panels, in particular for achieving improved spatial resolution and touch detection using a reduced number of wires and connections between sensor elements. Sensing devices manufactured using this disclosure may be useful in the fields of controlling electronics such as phones, tablets, PCs and cameras for both consumer and professional markets. Sensing devices manufactured in accordance with this disclosure could have applications including gaming, entertainment, communication, task support, medical, industrial design, navigation, and transport.

### REFERENCE SIGNS LIST

20—sensing device
22—partial ellipsoidal body
24—distal surface
26—pole
28—lines of longitude
30—lines of latitude
32—equator line
34—signal connection line
36—first layer
38—petal member
40—first end of petal member
42—second end of petal member
44—point of petal member
46—base of petal member
48—side of petal member
50—protruding tab
52—first layer
54—petal member
56—first end of petal member
58—second end of petal member
60—flat end of petal member
62—protruding tab
64—circular cap
66—sensor element
66a—sensor element
66b—vertical most sensor element
68—signal connection
70—ellipsoidal body
72—north pole
74—second layer
76—vertical spine
78—tab
80—coil
82—bottom end of vertical spine
84—top end of vertical spine
86—sensing element
88—signal connection
90—three-dimensional frustum body
92—sensing system
94—analog front end
96—device controller
98—stimulus generator
100—analog-to-digital converter
102—detection algorithm
104—application host
106—device driver
108—application
110—output

1. An electronic device comprising:
a first planar layer having a plurality of first sensing elements and a plurality of first signal connections connected between the first sensing elements, the plurality of first sensing elements and the plurality of first signal connections arranged substantially in a first direction;
a second planar layer having a plurality of second sensing elements and a plurality of second signal connections connected between the plurality of second sensing elements, the plurality of second sensing elements and the plurality of second signal connections arranged substantially in a second direction perpendicular to the first direction, and
a controller in electrical communication with the plurality of first sensing elements and the plurality of second sensing elements,
wherein one of the first planar layer and the second planar layer overlays the other of the first planar layer and the second planar layer forming a mesh, and
wherein each of the first planar layer and the second planar layer are two-dimensional and flexed together to form a three-dimensional curved shape.

2. The electronic device of claim 1, wherein the plurality of first sensing elements and the plurality of second sensing elements are capacitive sensing elements that form a capacitive touch panel.

3. The electronic device of claim 1, wherein the first planar layer and the second planar layer form a partial ellipsoidal body having a pole and a flattened distal surface opposite the pole.

4. The electronic device of claim 3, wherein the partial ellipsoidal body is formed as a partial spherical body.

5. The electronic device according to claim 1, wherein the first planar layer includes a row of petal members extending in the first direction, wherein each of the petal members includes at least one column of the plurality of first sensing elements and the plurality of first signal connections.

6. The electronic device according to claim 5, wherein the petal members are tapered from a first end to a second end, and the plurality of first sensing elements decrease in size from the first end to the second end of the petal members.

7. The electronic device according to claim 6, wherein each of the petal members has a tab portion protruding from the first end, the tab portion being in electrical communication with the controller.

8. The electronic device according to claim 1, wherein the second planar layer includes a spine that extends in the first direction and a plurality of annular coils that extend from the spine in the second direction, wherein each of the plurality of annular coils includes at least one row of the plurality of second sensing elements and the plurality of second signal connections.

9. The electronic device according to claim 1, further comprising a preformed substrate of glass or plastic, wherein the first planar layer is glued to the substrate and the second layer is glued to the second planar layer.

10. The electronic device according to claim 1, wherein the plurality of first sensing elements and the plurality of second sensing elements are diamond-shaped.

11. The electronic device according to claim 1,
wherein the first planar layer overlays the second planar layer, the first planar layer having an outer diameter that is larger than the second planar layer, or,
wherein the second planar layer overlays the first planar layer, the second planar layer having an outer diameter that is larger than the first planar layer.

12. A sensing device comprising:
a partial ellipsoidal body having a pole and a distal surface distally opposite the pole, the partial ellipsoidal body including:
a first layer having a plurality of first sensing elements and a plurality of first signal connections connected between the first sensing elements, the plurality of first sensing elements and the plurality of first signal connections arranged in a first direction along lines of longitude that extend between the pole and the distal surface; and
a second layer having a plurality of second sensing elements and a plurality of second signal connections connected between the second sensing elements, the plurality of second sensing elements and the plurality of second signal connections arranged in a second direction perpendicular to the first direction along lines of latitude that extend along planes parallel to the distal surface, wherein one of the first layer and the second layer overlays the other of the first layer and the second layer forming a mesh; and
a controller in electrical communication with the first sensing elements and the second sensing elements.

13. The sensing device according to claim 12, wherein the partial ellipsoidal body is formed as a partial spherical body.

14. The sensing device according to claim 12, wherein the first sensing elements and the second sensing elements are capacitive sensing elements that form a capacitive touch panel.

15. The sensing device according to claim 12, wherein the first layer includes a plurality of petal members that extend along the lines of longitude and each include at least one column of the plurality of first sensing elements and the plurality of first signal connections, the petal members being tapered from the distal surface to the pole, the plurality of first sensing elements decreasing in size from the distal surface to the pole, and each of the petal members having a tab portion that protrudes from the distal surface and is in electrical communication with the controller.

16. The sensing device according to claim 12, wherein the second layer includes a spine that extends from the pole to the distal surface and a plurality of annular coils that extend from the spine, wherein each of the plurality of annular coils includes at least one row of the plurality of second sensing elements and the plurality of second signal connections.

17. The sensing device according to claim 12, further comprising a preformed substrate of glass or plastic, wherein the first layer is glued to the former and the second layer is glued to the second planar layer.

18. The sensing device according to claim 12, wherein the plurality of first sensing elements and the plurality of second sensing elements are diamond-shaped.

19. A method for manufacturing a three-dimensional sensing device, the method comprising:
forming a first planar layer having a plurality of first sensing elements and a plurality of first signal connections connected between the first sensing elements, the plurality of first sensing elements and the plurality of first signal connections arranged substantially in a first direction;
forming a second planar layer having a plurality of second sensing elements and a plurality of second signal connections connected between the second sensing elements, the plurality of second sensing elements and the plurality of second signal connections arranged substantially in a second direction perpendicularly to the first direction;
connecting the first planar layer and the second layer to a controller, the controller being in electrical communication with the plurality of first sensing elements and the plurality of second sensing elements;
overlaying one of the first planar layer and the second planar layer over the other of the first planar layer and the second planar layer to form a mesh; and
flexing the first planar layer and the second planar layer to form a three-dimensional curved shape.

20. The method of claim 19 further comprising:
forming the first planar layer having a plurality of petal members that extend along the lines of longitude;
overlaying the plurality of petal members over the plurality of first sensing elements and the plurality of first signal connections;
forming the second planar layer having a spine that extends from the pole to the distal surface and a plurality of annular coils that extend from the spine;
overlaying the plurality of annular coils over the plurality of second sensing elements and the plurality of second signal connections;
removing portions of the plurality of petal members that do not contain the plurality of first sensing elements and the plurality of first signal connections; and
removing portions of the plurality of annular coils that do not contain the plurality of second sensing elements and the plurality of second signal connections.
